(19) United States
(12) Patent Application Publication
(10) Pub. No.: US 2008/0170768 A1
(43) Pub. Date: Jul. 17, 2008

(54) REGION CORRECTION METHOD

(75) Inventor: Kazuhiko Matsumoto, Tokyo (JP)

Correspondence Address: PEARNE & GORDON LLP, 1801 EAST 9TH STREET, SUITE 1200, CLEVELAND, OH, 44114-3108, US

(73) Assignee: ZIOSOFT INC., Toyko (JP)

(21) Appl. No.: 11/972,909

(22) Filed: Jan. 11, 2008

(30) Foreign Application Priority Data
Jan. 16, 2007 (JP) 2007-007110

(51) Int. Cl. G06K 9/00

(52) U.S. Cl. 382/128

(57) ABSTRACT

In a region correction method of correcting a three-dimensional region on volume data, the region correction method includes: (a) acquiring a first region as a guide and a second region as a work region; (b) rendering the first region and the second region separately from each other; (c) acquiring a third region specified by a user; and (d) adding a region resulting from AND operation of the third region and the first region into the second region or subtracting the region from the second region.

This application is based on and claims priority from Japanese Patent Application No. 2007-007110, filed on Jan. 16, 2007, the entire contents of which are hereby incorporated by reference.

### BACKGROUND OF THE INVENTION

1. Technical Field

This invention relates to a region correction method of correcting a region on volume data.

2. Related Art

Hitherto, image analysis has been conducted for directly observing the internal structure of a human body according to the tomographic image of a living body photographed with a Computed Tomography (CT) apparatus, a Magnetic Resonance Imaging (MRI) apparatus, or the like. Further, volume rendering has been conducted in recent years. The volume rendering represents a three-dimensional space by voxels (volume elements) and the voxels are separated small like a lattice based on digital data (volume data) generated by stacking tomographic images by a CT apparatus, an MRI apparatus, or the like. Then, the volume rendering method renders a distribution of the concentration and the density of an object as a translucent three-dimensional image. Thus, the volume rendering makes it possible to visualize the inside of a human body hard to understand simply from the tomographic image of the human body.

FIGS. 13 to 15 are schematic views for extracting a three-dimensional region of an organ (cardiac ventricle shown in FIG. 14) where three-dimensional information of a human body (information centering on a heart shown in FIG. 13) exists. The region of the cardiac ventricle is extracted, whereby the three-dimensional shape and the volume of the cardiac ventricle can be checked in detail and also a lesion can be found. In the image in FIG. 13, the appearance of the heart is displayed and the cardiac ventricle is behind a cardiac wall and thus is not displayed in the three-dimensional image. Then, to render the cardiac ventricle for diagnosis, a three dimensional region is extracted. FIG. 14 shows the ventricle of the heart extracted from the three dimensional image (volume data) of the heart, which consists of plurality of two-dimensional images (for example, tomographic images). The user sets the contours of the cardiac ventricle (dotted line region 51) one after another on the two-dimensional images included in volume data with a mouse, etc., and then creates a three-dimensional region created by stacking the contours on the two-dimensional images. A three-dimensional region can also be created using a region extraction algorithm as described in the following Non-patent document: “Gradient Vector Flow Deformable Models, Chenyang Xu”. If the region 51 created using the region extraction algorithm is inappropriate as shown in FIG. 15A, the user can make a command to add the eclipsed region of 53 on two dimensional image into region 51 in order to make region 54 as shown in FIG. 15B.

Thus, to extract the three-dimensional region of the displayed organ (cardiac ventricle in FIG. 13) from the two-dimensional images displayed on the monitor, the user manually marks the three-dimensional region of the organ with a mouse, etc. However, to manually set a region for three-dimensional data, manipulation on a large number of two-dimensional images is required. This requires with too much labor. Since the region contours are set manually, the result becomes subjective. Further, three-dimensional region creating through a three-dimensional modeling technology used in computer-aided design (CAD), etc., is not suited to accurate modeling of a complicated living body shape.

On the other hand, when the three-dimensional region displayed on a monitor is manipulated, since the region is manipulated through the monitor which is a two-dimensional plane, only two-dimensional position can be specified and it requires some technique to specify the positions in the depth direction. Further, even if the exact position in three-dimensional position is specified, it is much more difficult to specify the region in three-dimensional position. Namely, it is difficult to execute three-dimensional manipulation on a computer regardless of the type of displayed image. In the other hand, even when an automatic extraction algorithm is used, the desirable result cannot necessarily be obtained.

As an approach, the user can correct the result extracted by automatic algorithm by means of manual extraction. Certainly, the labor is lightened, it is still difficult to perform a manual correction, and the result becomes subjective.

Further, as another approach, it is possible that the best result is obtained by adjusting parameters of the automatic extraction algorithm in case where the region of the result of the automatic extraction algorithm is insufficient. However, it is difficult to set the parameters and the desirable result may not be obtained regardless of how to set the parameters.

### SUMMARY OF THE INVENTION

Accordingly, the present invention provides a region correction method for enabling the user to easily perform a manual correction objectively in extracting a region of an organ, etc., from an image displayed on a monitor.

According to one or more aspects of the present invention, a region correction method of correcting a three-dimensional region on volume data, said region correction method comprises:

(a) acquiring a first region as a guide and a second region as a work region;

(b) rendering the first region and the second region separately from each other;

(c) acquiring a third region specified by a user; and

(d) adding a region resulting from AND operation of the third region and the first region into the second region.

According to another aspect of the present invention, a region correction method of correcting a three-dimensional region on volume data, said region correction method comprises:

(a) acquiring a first region as a guide and a second region as a work region;

(b) rendering the first region and the second region separately from each other;

(c) acquiring a third region specified by a user; and

(d) subtracting a region resulting from AND operation of the third region and the first region from the second region.

According to another aspect of the present invention, in the step (c), a region set by user's manipulation may be acquired as the third region.

According to another aspect of the present invention, in the step (c), the third region may be acquired by selecting from among a plurality of regions.

According to another aspect of the present invention, the region correction method further comprises:

(e) expanding the third region in stages.

According to another aspect of the present invention, the region correction method further comprises:

(f) changing the first region.

According to another aspect of the present invention, the region correction method further comprises:

(g) rendering only a region in the range included in a fourth region which is a part of the volume data.

According to another aspect of the present invention, the third region may include a region not included in the fourth region.

According to another aspect of the present invention, an image-analysis apparatus has a region correction function to perform operations comprising:

(a) acquiring a first region as a guide and a second region as a work region;

(b) rendering the first region and the second region separately from each other;

(c) acquiring a third region specified by a user; and

(d) adding a region resulting from AND operation of the third region and the first region into the second region.

According to another aspect of the present invention, an image-analysis apparatus has a region correction function to perform operations comprising:

(a) acquiring a first region as a guide and a second region as a work region;

(b) rendering the first region and the second region separately from each other;

(c) acquiring a third region specified by a user; and

(d) subtracting a region resulting from AND operation of the third region and the first region from the second region.

### BRIEF DESCRIPTION OF THE DRAWINGS

In the accompanying drawings:

FIGS. 1A to 1C are drawings (part 1) to describe an outline of a region correction method according to an embodiment of the invention;

FIGS. 2A to 2D are drawings (part 2) to describe an outline of the region correction method according to the embodiment of the invention;

FIGS. 3A to 3C are schematic views for manually manipulating a region in a region correction method according to a first embodiment of the invention;

FIG. 4 is a flowchart for manually manipulating a region in the region correction method according to the first embodiment of the invention;

FIGS. 5A to 5C are schematic views for selecting a region in a region correction method according to a second embodiment of the invention;

FIGS. 6A to 6E are schematic views (part 1) for expanding a region in stages in a region correction method according to a third embodiment of the invention;

FIGS. 7A and 7B are schematic views (part 2) for expanding a region in stages in the region correction method according to the third embodiment of the invention;

FIGS. 8A to 8D are schematic views for changing a guide region midway in a region correction method according to the fourth embodiment of the invention;

FIG. 9 is a flowchart for changing a guide region midway in the region correction method according to the fourth embodiment of the invention;

FIGS. 10A to 10C are schematic views for rendering only the range contained in a fourth region (rendering range) in a region correction method according to the fifth embodiment of the invention;

FIG. 10D is a schematic view for rendering only the range contained in a fourth region (rendering range) in the region correction method according to the fifth embodiment of the invention;

FIGS. 11A to 11D are drawings to describe subtracting from a work region in a region correction method according to a sixth embodiment of the invention;

FIG. 12 is a flowchart showing a ray casting algorithm of distinctly rendering a plurality of regions in the region correction method according to the embodiment of the invention;

FIG. 13 is a schematic view (part 1) for extracting a three-dimensional region of a displayed organ from two-dimensional images displayed on a monitor;

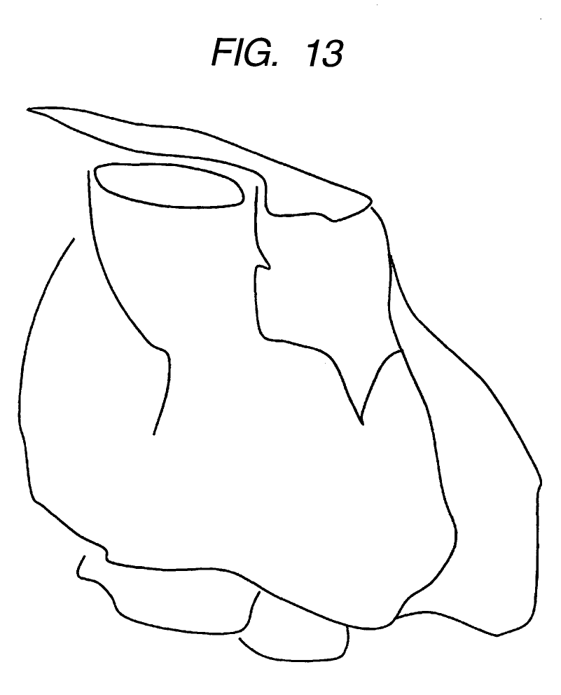

FIG. 14 is a schematic view (part 2) for extracting a three-dimensional region of a displayed organ from two-dimensional images displayed on a monitor; and

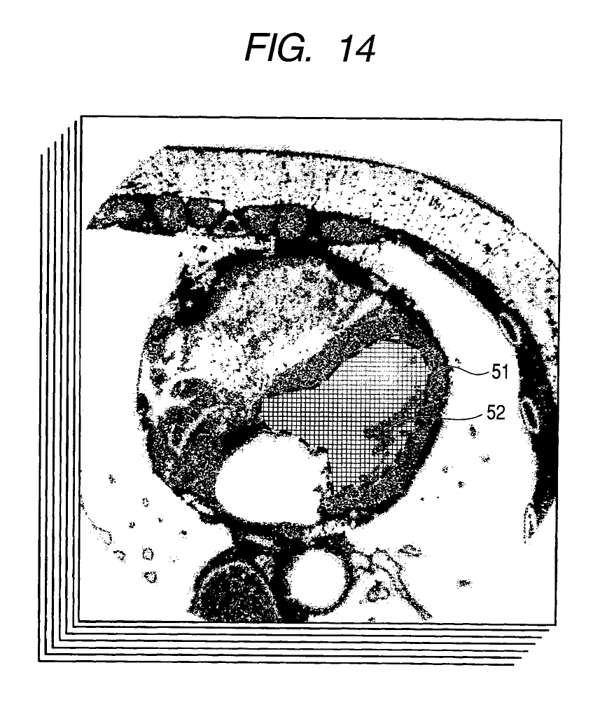

FIGS. 15A and 15B are schematic views (3) for extracting a three-dimensional region of a displayed organ from two-dimensional images displayed on a monitor.

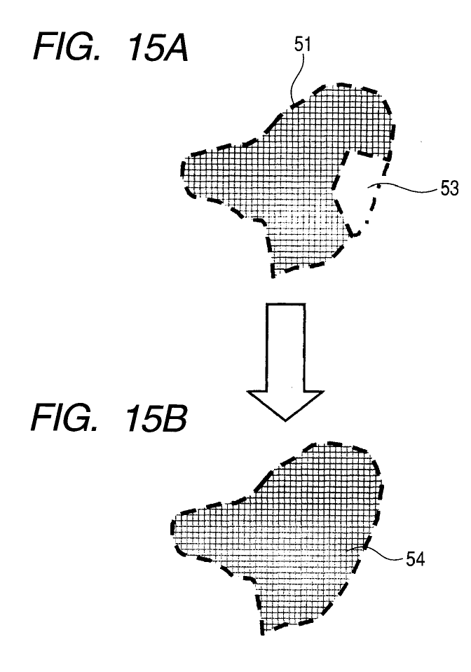

### DETAILED DESCRIPTION OF EXEMPLARY EMBODIMENTS

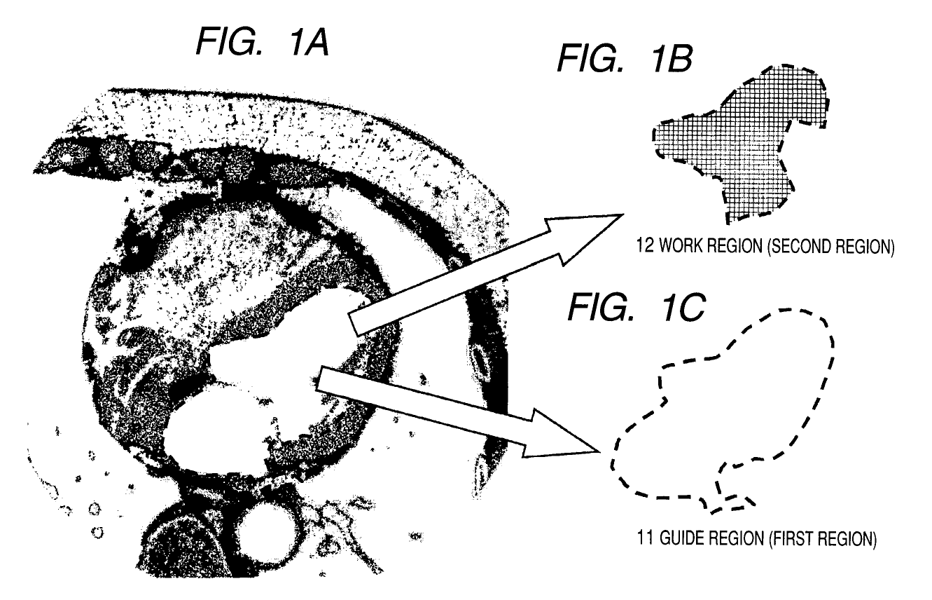

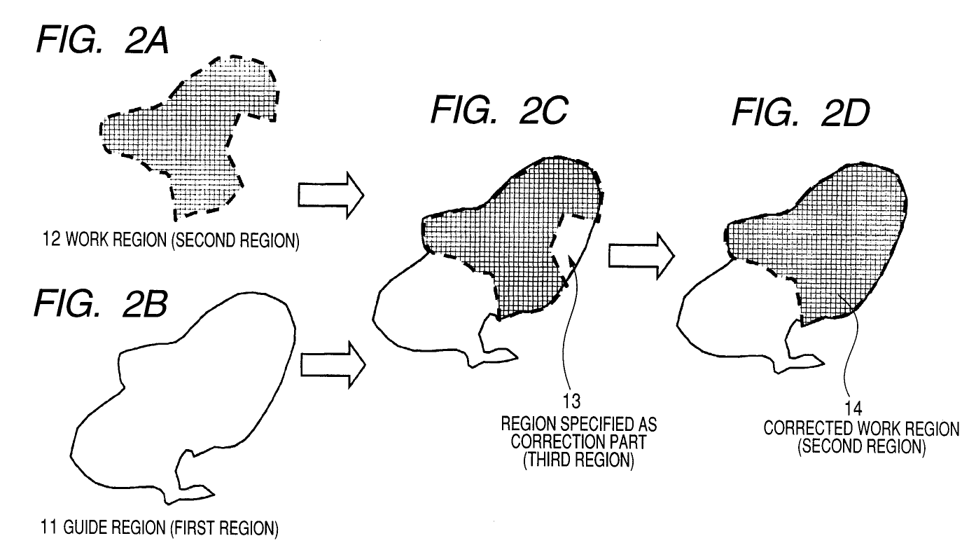

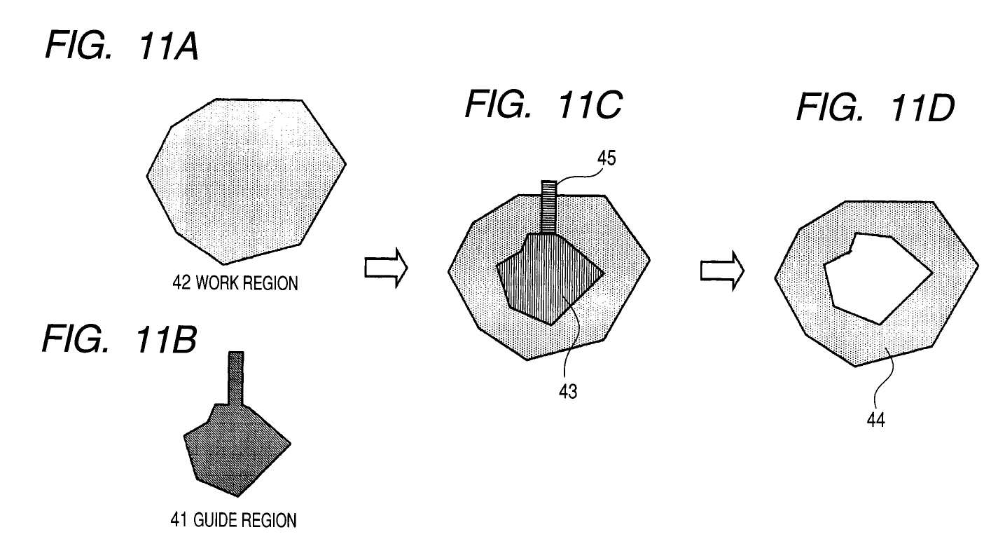

FIGS. 1 and 2 are drawings to describe an outline of a region correction method according to an embodiment of the invention. According to the region correction method of the embodiment, firstly (1) a guide region 11 (first region) for reference is previously prepared. Namely, the guide region 11 (first region) which becomes a candidate for the boundary of the target region is set as shown in FIG. 1C for the whole image shown in FIG. 11A.

In this case, the guide region 11 can be set according to a known automatic extraction method and the user need not perform any operation for preparing the guide region 11, but may specify a threshold value, a template, a region extraction method, etc. For example, when a representative of doctors fix a common value for the threshold value, this value becomes an objective criterion among doctors, and it is needless for them to manipulate the threshold value.

Next, (2) a work region 12 (second region) is corrected using the guide region 11. The work region 12 (shown in FIG. 1B, FIG. 2A) is a region to which the user can add change to form an object region. To execute correction work, the user specifies a region (third region) 13 as a correction part in the guide region 11 as shown in FIG. 2C. It is assumed that the work region is previously given according to some method. To set an initial region of the work region, the user may manually set the region or the region may be created based on a threshold value, a template, a region extraction method, etc. The initial region of the work region may be an empty region.

When the correction work is executed, the region resulting from AND operation of the guide region 11 and the region (third region) 13 specified as the correction part is added to the work region 12. After the correction is done, the region, which is made by AND operation between the guide region 11 and the specified region (third region) 13, is added (OR operation) to the work region 12.

According to the region correction method of the embodiment, the user selects the region of the difference between the regions created based on the two types of region specification methods (work region 12 and guide region 11) to complete the work region 14 as the object region. The user selects the region, but need not create the work region 12 before correction. In the correction of the work region 12, strictly speaking, there are two steps: One is the creation of a region 13 (third region) specified as a correction part, and the other is user's selection. The user must always execute the selection step.

In the first embodiment described later, the user executes the creation step of a region (third region) 13 specified as a correction part and thus the two steps (creation step and selection step) are united together. On the other hand, in a second embodiment, a program executes the creation step of a third region 13. The work region 12 may be created and corrected by the program or may be created and corrected by the user.

Thus, in the region correction method of the embodiment, the correction range of the work region 12 is limited in the range of the guide region 11 by using the difference between both regions. If the correction is unlimitedly performed by hand, the objectivity is not preserved. In this proposed method, the region that the user manipulates is limited. Therefore, the correction work becomes more objective and simple. The guide region 11 and the work region 12, 14 are both displayed at once in a superposition manner. Thus, the user easily estimates the correction result, it is not the with the parameter adjustment of the automatic region extraction algorithm.

The guide region 11 is (1) region obtained using region extraction by threshold value processing, (2) region obtained using region expansion method, (3) region obtained using region extraction based on GVF method, Level Set method, etc., (4) region specified by user hand, (5) region specified according to template form, etc. The guide region 11 may be defined by applying a complicated algorithm as in (3). Meanwhile, to use a method of defining the guide region 11 as a region with constant CT value included in a given range as in (1) or (2), it would be advantageous to ensure objectivity. For example, when a criterion is defined as blood contrasted with a contrast medium being CT value 150 or more, the same criterion is applied across a plurality of diagnoses, the objectivity of diagnoses is preserved. The guide region 11 may be provided by the AND operation between the region provided by a complicated algorithm, such as (3), and that of an algorithm with a constant CT value, such (1) or (2).

### First Embodiment

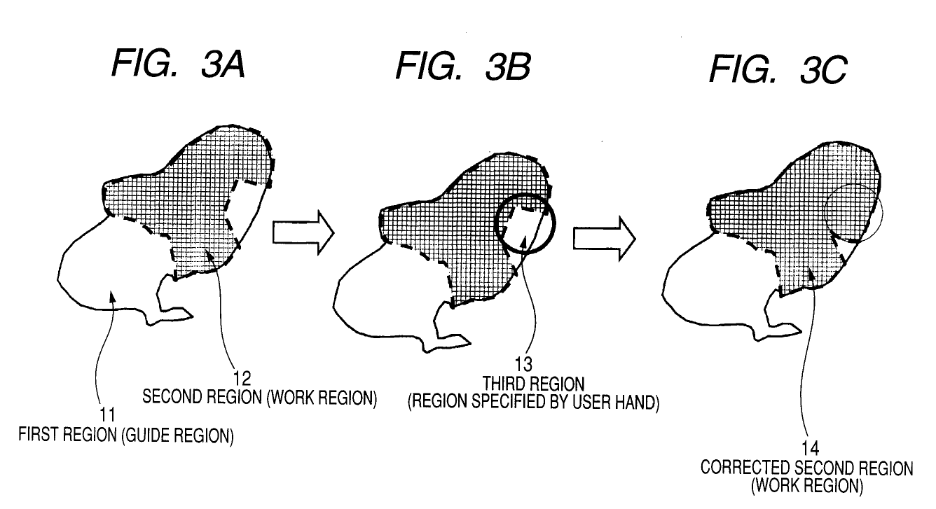

FIGS. 3A to 3C are schematic views for manually manipulating a region in a region correction method of a first embodiment. In the region correction method of the embodiment, a region is assigned using the user-specified point as the center. For example, now there exist the first region (guide region) 11 and the second region (work region) 12, as shown in FIG. 3A. If the user specifies the third region (spherical region) 13 shown in FIG. 3B, the region made by AND operation between the third region 13, and the first region 11 is added (OR operation) to the second region (work region) 12. Finally, region 14 is made as shown in FIG. 3C.

According to the region correction method of the embodiment, the third region 13 can be specified independently of the first region (guide region) 11 and the second region (work region) 12 and the region can be expanded three-dimensionally. The first to third regions are three-dimensional regions and the sections of the three-dimensional regions can also be displayed on the monitor or each three-dimensional region can also be displayed as a three-dimensional image on the monitor.

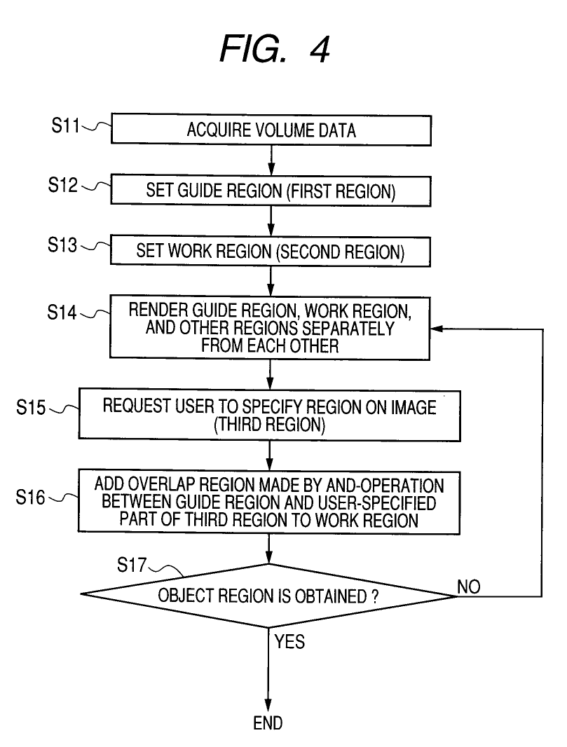

FIG. 4 is a flowchart of the region correction method of the embodiment. According to the region correction method of the embodiment, firstly, volume data is acquired (step S11), a guide region (first region) 11 is set (step S12), and the initial value of a work region (second region) 12 is set (step S13).

Next, the guide region 11, the work region 12, and other regions are rendered as distinguished from each other (step S14) and the user is requested to specify a third region 13 on the image (step S15). The overlap region is made by AND operation between the guide region 11 and the user-specified part of the third region 13, and it is added to the work region 12 (step S16).

Next, whether or not an object region is acquired is determined (step S17). If the object region is obtained (YES), the processing is terminated; if the object region is not obtained (NO), steps S14 to S16 are repeated.

According to the region correction method of the embodiment, the correction range of the work region 12 is limited to the range of the guide region 11, whereby manual correction can be made easily with objectivity being ensured. The guide region 11 and the work region 12, 14 are both displayed in a superposition manner, whereby the user easily estimates the correction result. It is difficult for the user to directly specify a three-dimensional shape in the related arts; in the embodiment, however, the third region specified by the user can be a region that can be easily specified such as a spherical region, for example. Consequently, the user can easily acquire the object region. In general, it is difficult to directly specify a three-dimensional shape in a traditional manner. In the proposed method, the user can specify an arbitrary three-dimensional shape by virtue of the third region, for which the user can use the spherical region. Particularly, the method is applied to a three-dimensional region and thus easy manipulation can be conducted, also including an undisplayed region such as the back of a body. The third region specified by the user that can be easily specified can be a primitive shape region of a pillar, a cone, etc., or a region provided by sweeping the regions, for example.

### Second Embodiment

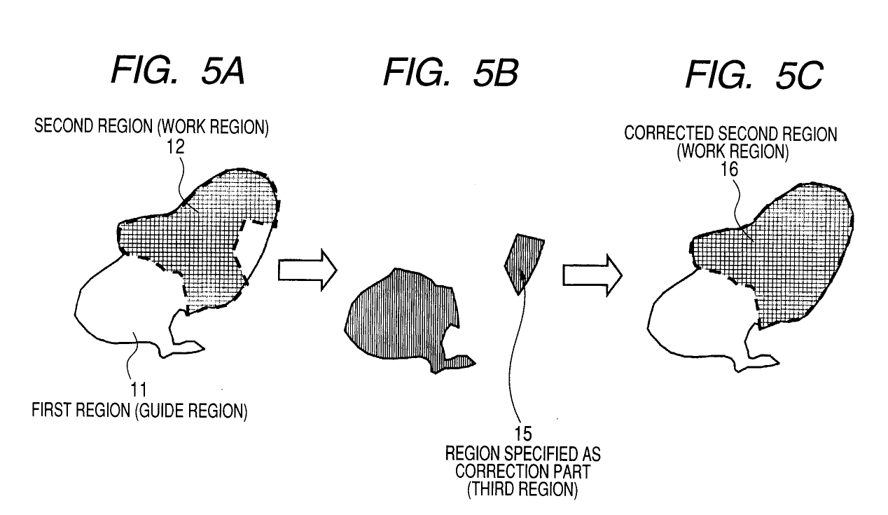

FIGS. 5A to 5C are schematic views for selecting a region in a region correction method of a second embodiment. In the region correction method of the embodiment, the user specifies one point, whereby a region containing the specified point is added to the region to be extracted. In this case, difference between the guide region 11 and the work region 12 is acquired. Then, one of the appropriate regions extracted from the difference is selected.

Namely, when a first region (guide region) 11 and a second region (work region) 12 are set as shown in FIG. 5A, if the user specifies one point in the first region (guide region) 11 as a correction part as shown in FIG. 5B, a region containing the point is selected as a third region 15. The third region 15 is added to the second region (work region) 12 to form a corrected second region (work region) 16 as shown in FIG. 5C.

According to the region correction method of the embodiment, if the user specifies one point in the first region (guide region) 11 as a correction part, the whole region containing the point is selected as the third region 15, so that manual correction is facilitated.

### Third Embodiment

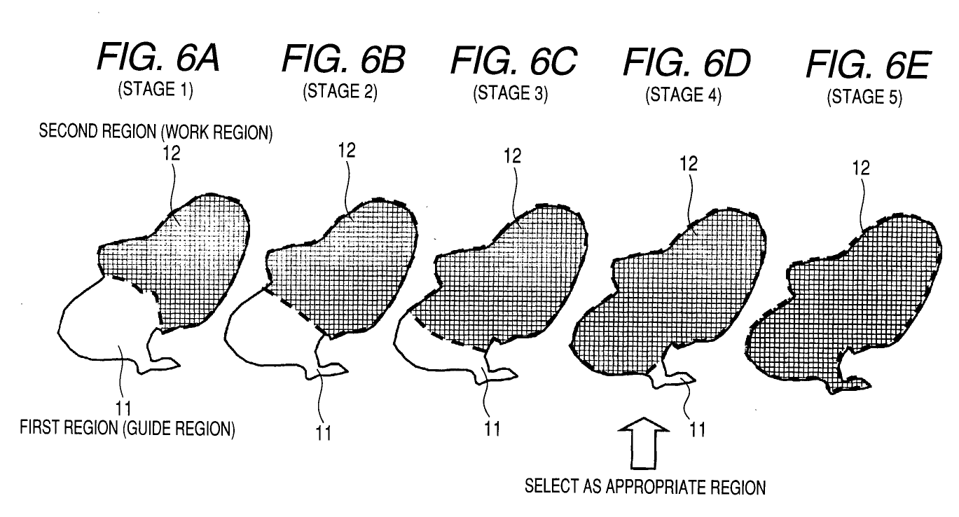

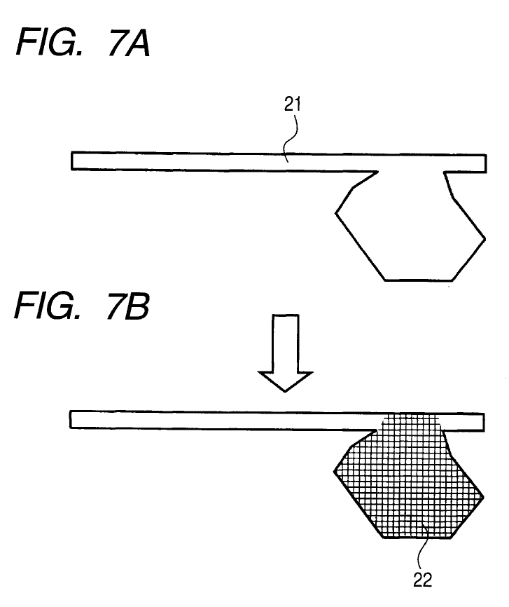

FIGS. 6 and 7 are schematic views for expanding a region gradually in a region correction method of a third embodiment. According to the region correction method of the embodiment, the region to be added is divided into a plurality of stages and each stage is displayed in succession by mouse drug, etc.

Now, there exist the first region (guide region) 11 and the second region (work region) 12 in stage 1, as shown in FIG. 6A. The user expands the third region gradually, as shown in stage 2 to stage 5 (FIG. 6B to FIG. 6E). Along with this process, the second region is also expanded simultaneously and its expanded part is displayed. The user expands the third region as an appropriate region (stage 4) by dragging a mouse, for example. When, the third region satisfied the user, the may fix the second region.

The region correction method of the embodiment is effective particularly if the user wants to acquire only a region 22 double hatched in FIG. 7B (only heart) when a shape 21 as in FIG. 7A (for example, heart and blood vessel) exists, for example.

### Fourth Embodiment

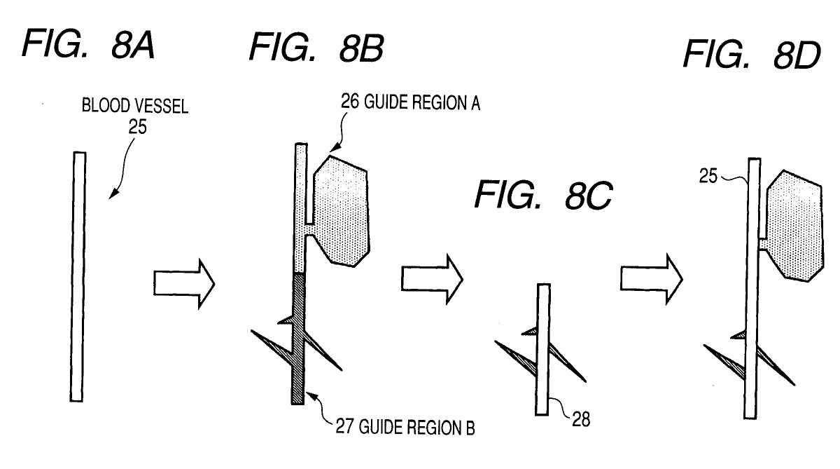

FIGS. 8A to 8D are schematic views for switching a guide region midway in a region correction method of a fourth embodiment. When the user wants to acquire a blood vessel 25 as shown in FIG. 8A, the desired guide region is created by switching the guide region of A26 with that of B27, where the guide region of A26 and that of B27 are made by algorithm A and Algorithm B, respectively.

FIG. 8C shows a phase in which a lower region 28 (white rectangle) of a blood vessel 25 is created using the guide region B 27. FIG. 8D shows a phase in which after the region of the blood vessel 28 (white rectangle) in FIG. 8C is created, the guide region B 27 is switched to the guide region A 26 and the guide region A 26 is used to create a remaining region of the blood vessel 25 (longer white rectangle).

Thus, the effective phase varies from one region extraction algorithm to another; however, the region extraction algorithms can be efficiently combined using the proposed method. If a region is created while the guide region is switched, the effective region extraction algorithms can be combined for each phase (the type, shape, etc., of organ), so that only the necessary region can be acquired accurately and efficiently. Even with the same algorithm, it is also effective to change each parameter to the effective value for each phase.

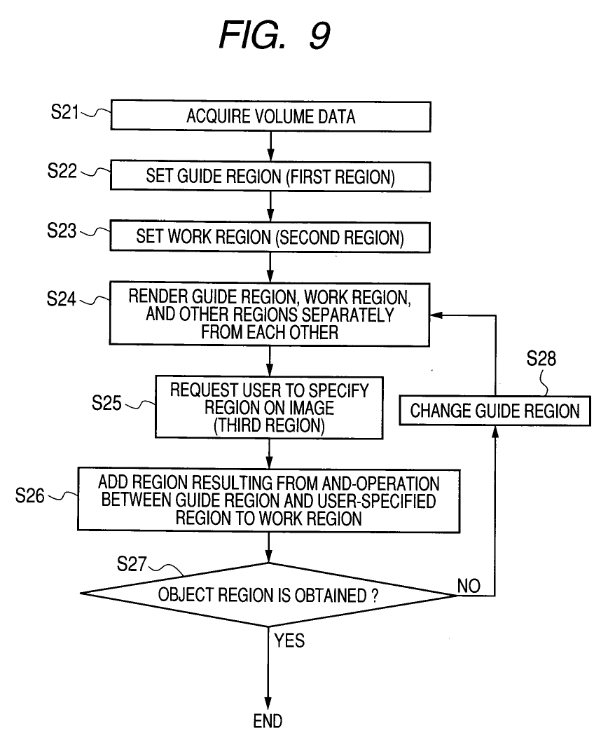

FIG. 9 shows a flowchart of the region correction method of the embodiment. In the region correction method of the embodiment, first, volume data is acquired (step S21), a guide region (first region) 11 is set (step S22), and a work region (second region) 12 is set (step S23).

Next, the guide region, the work region, and other regions are rendered as distinguished from each other (step S24) and the user is requested to specify a third region on the image (step S25). A region resulting from AND operation between the guide region and the resulting region specified by the user is added to the work region (step S26).

Next, whether or not a desired region is acquired is determined (step S27). If the desired region is not acquired (NO), the guide region is changed (step S28) and steps S14 to S27 are repeated. On the other hand, if the desired region is acquired (YES), the processing is terminated.

According to the region correction method of the embodiment, some types of the effective region extraction algorithm proper for each extraction phase, which depends on the type, shape, etc. The effective region extraction algorithms can be combined for each phase (the type, shape, etc., of organ) while the guide region is switched, so that only the necessary region can be acquired accurately and efficiently.

### Fifth Embodiment

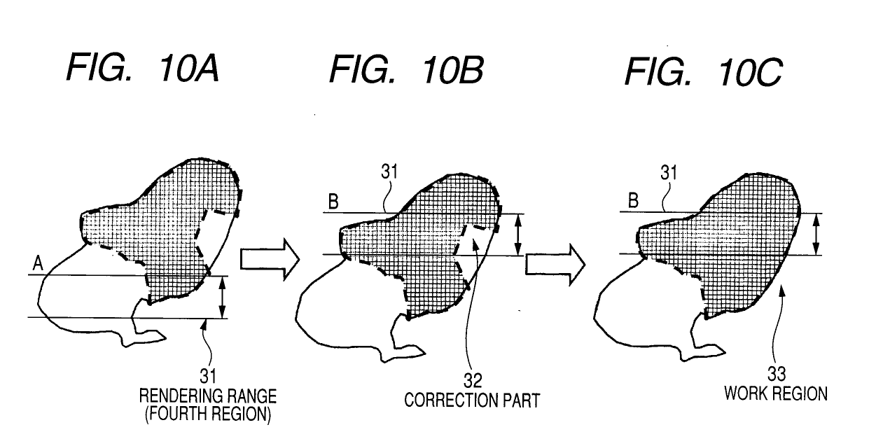

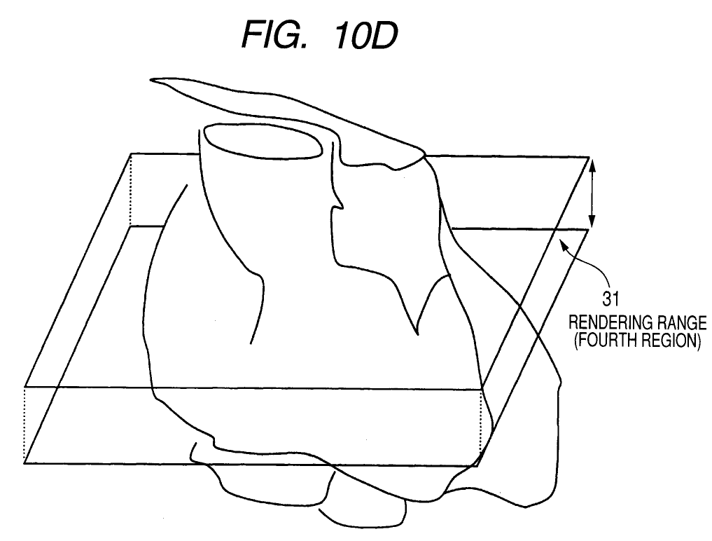

FIGS. 10A to 10D are schematic views for rendering only the range contained in a fourth region according to a region correction method of a fifth embodiment. In the region correction method of the embodiment, a rendering range 31 is moved from A to B to check the whole or to find a part which needs correction, as shown in FIGS. 10A and 10B. The rendering range 31 can be changed as desired independently of first to third regions (guide region, work region, and user-specified region). Here, the rendering range 31 is based on a region (fourth region) sandwiched between two parallel planes as in FIG. 10D. Where, specifying and rendering of a region sandwiched between two parallel planes are widely conducted in a medical three-dimensional image apparatus and it is familiar to many users.

Next, the user specifies a correction part 32 by specifying directly positions with a mouse, etc., in the rendering range 31(B), as shown in FIG. 10B. The correction part (third region) 32 is a part within the rendering range 31 (B) with the positions directly specified using a mouse, etc., by the user. Accordingly, a work region 33 containing both the inside and the outside of the rendering range 31 (B) is corrected as shown in FIG. 10C.

Thus, the user can specify directly the positions with the mouse, etc., only in the rendering range 31 (B), but the correction part (third region) 32 acquired as a result of user's position specification is not limited to the range in the rendering range 31 (B).

Consequently, the region corrected in the work region 33 is not limited to the rendering region (fourth region) 31. For the reason, when a program executes region extraction, etc., using the part specified as the correction part and then acquires a third region exceeding the rendering region (fourth region) 31, the corrected region resulting from AND operation of the third region and the guide region (first region) may contain a region outside the rendering region (fourth region).

The rendering region (fourth region) is not limited to a region sandwiched between two parallel planes and may be a region of any desired shape. For example, it may be the template shape of an organ or may be a region created with some algorithm. The rendering region (fourth region) may be a region provided by expanding any of the first to third regions (guide region, work region, user-specified region) a given amount. In so doing, the rendering region (fourth region) can be expanded in accordance with change in the work region, for example. The first to third regions (guide region, work region, and user-specified region) are three-dimensional regions. In general, the rendering region (fourth region) is three-dimensional. However, it may be two-dimensional if it consists of a single CT or MRI slice (including NPR cross section).

When the rendering region limited to a part the region correction method of the embodiment applies to a three-dimensional image (image subjected to volume rendering), user positioning of the calculation start point is made easy.

The rendering region is limited to a part of a three-dimensional region, whereby a region not required for the user is not displayed, so that user's specification is facilitated (e.g., user can click easily). In other words, the rendering region is limited to a part of a three-dimensional region to suppress display of a region which becomes an obstacle for the user to specify the third region; although not displayed, the work region (second region) corresponds to a region required for the user.

The region correction method of the embodiment is effective particularly when the structure of target organs is weaved complicated, the region to be corrected may be hidden by the front organ (obstacle region) and is not rendered. The region correction method of the embodiment is effective when a blood vessel region is an object region, because the blood vessel runs in a complicated way before and after and inside and outside the organs and is hard to recognize unless rendering the surrounding organs is limited.

The region correction method of the embodiment assumes a state in which a volume rendering image of volume data (three-dimensional image) is displayed on a monitor, but the user can also be requested to specify the correction part on a two-dimensional section of volume data.

### Sixth Embodiment

FIGS. 11A to 11D are drawings to describe subtracting from a work region in a region correction method of a sixth embodiment. If a hollow tissue exists, a region 43 (FIG. 11C) corresponding to a part of a guide region 41 shown in FIG. 11B (a region obtained by removing a projection part 45 from the guide region 41) is deleted from a work region 42 shown in FIG. 1A, whereby a third region is specified and an object tissue 44 as shown in FIG. 11D can be extracted.

If the user deletes the region 43 corresponding to a part of the guide region 41 from the work region 42, region subtraction is executed in computer internal processing. Namely, when the user specifies a third region, the computer subtracts the region resulting from AND operation between the third region specified by the user and the first region (guide region) from the second region (work region). Thus, the contours of the region 43 can be easily subtracted using the guide region 41. On the other hand, the region on the projection part 45 to be left in the object region can be excluded from the subtraction region.

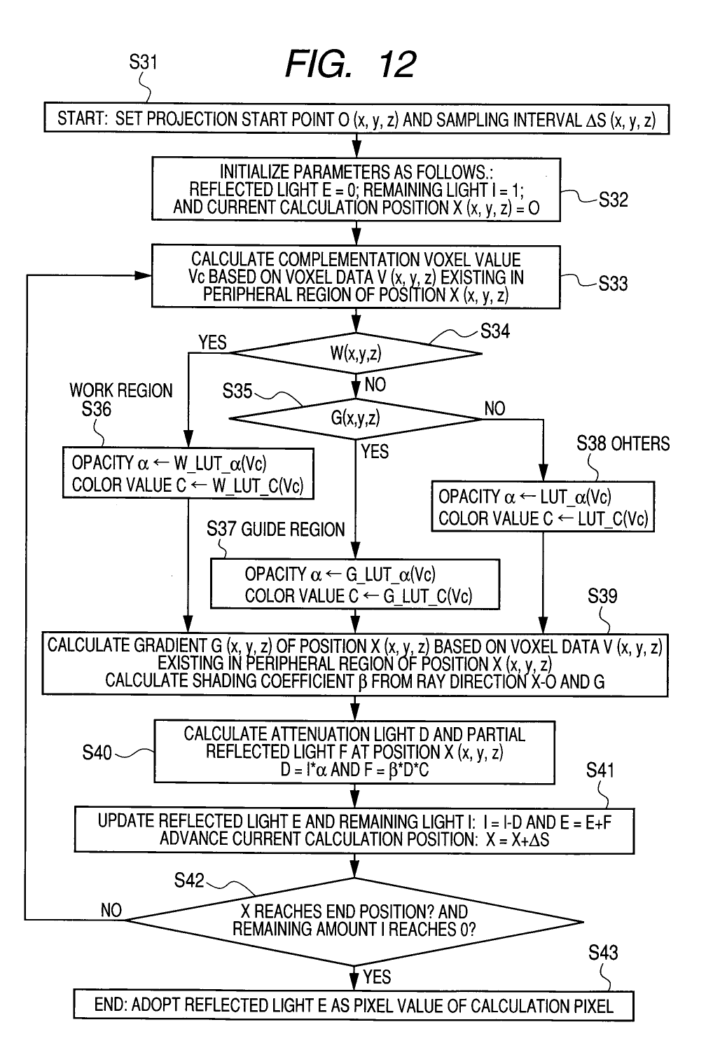

FIG. 12 is a flowchart showing a ray casting algorithm in the region correction method of the embodiment. In the ray casting algorithm, a plurality of regions are distinguished and rendered separately. In the flowchart, the color value of the guide region C and its opacity α are described as G_LUT_C(V) and G_LUT_α(V) respectively. The color value C of the work region and its opacity a are described as W_LUT_C(V) and W_LUT_α(V) respectively. The color value C of any other region and its opacity α are described as LUT_C(V) and LUT_α(V) respectively.

V (x, y, z) has the voxel value in positions (x, y, z). G (x, y, z) has the information about whether positions (x, y, z) are contained in the guide region or not. W (x, y, z) has the information about whether positions (x, y, z) are contained in a work region or not. This information is set in advance. The flowchart describes how to calculate each pixel on an image, and the following calculation is performed on all pixels on the image:

First, projection start point O (x, y, z) and sampling interval ΔS (x, y, z) are set (step S31). The parameters are initialized as follows (step S32): reflected light E=0; remaining light I=1; and current calculation position X (x, y, z)=projection start point O.

Next, complementation voxel value Vc is calculated based on voxel data V (x, y, z) existing in a peripheral region of the positions X (x, y, z) (step S33). Whether or not the positions X (x, y, z) are contained in the work region is judged based on W (x, y, z) (step S34). If the positions X (x, y, z) are contained in the work region (YES), the process goes to step S36; if the positions X (x, y, z) are not contained in the work region (NO), whether or not the positions X (x, y, z) are contained in the guide region is judged based on G (x, y, z) (step S35). If the positions X (x, y, z) are contained in the guide region (YES), the process goes to step S37; if the positions X (x, y, z) are not contained in the guide region (NO), the process goes to step S38.

Next, if the positions X (x, y, z) are contained in the work region, opacity α←W_LUT_α(Vc) and color value C←W_LUT_C(Vc) (step S36). If the positions X (x, y, z) are contained in the guide region, opacity α←G_LUT_α(Vc) and color value C←G_LUT_C(Vc) (step S37). If the positions X (x, y, z) are contained in neither the work region nor the guide region, opacity α←LUT_α(Vc) and color value C←LUT_C(Vc) (step S38).

Next, gradient G (x, y, z) of the position X (x, y, z) is calculated based on the voxel data V (x, y, z) in peripheral region of position X (x, y, z) and a shading coefficient β is calculated from ray direction X-O and G (step S39). Attenuation light D and partial reflected light F are calculated and then D←I*α and F←β*D*C (step S40).

Next, the reflected light E and the remaining light I are updated as I←I-D and E←E+F and the current calculation position is advanced as X←X+ΔS (step S41). Whether or not X reaches the end position and whether or not the remaining amount I reaches 0 is determined (step S42). If the X is not the end position and the remaining amount I is not 0 (NO), the process returns to step S33. On the other hand, if X reaches the end position or the remaining amount I reaches 0 (YES), the reflected light E is adopted as the pixel value of the calculation pixel and the processing is terminated (step S43).

According to the region correction method of the embodiment, the correction range of the work region is limited to the range of the guide region, so that manual correction can be performed easily while the objectivity of the guide region is ensured. Further, the guide region and the work region are both displayed in a superposition manner, so that the user easily estimates the correction result.

According to the present invention, the correction range of the second region as a work region is limited to the range of the first region as a guide, whereby correction can be easily performed while the objectivity is ensured. The first region and the second region are both displayed, so that the user easily estimates the correction result.

According to the present invention, a GUI for aiding in user's manipulation for setting the third region can be provided, so that region creation is facilitated.

According to the present invention, the user selects one region from among a plurality of candidate regions as the third region, so that correction is facilitated.

According to the present invention, the third region is expanded in stages, so that the user can easily estimate the post-corrected region.

According to the present invention, while the first region as a guide is switched, the effective region extraction algorithms can be combined for each phase (the type, shape, etc., of organ) and the parameter of the algorithm can be changed, so that only the necessary region can be acquired accurately and efficiently.

According to the present invention, the fourth region (rendering region) is limited to a part of the three-dimensional region, whereby the user can intuitively grasp the part to be corrected, so that specification is still more facilitated.

According to the present invention, a region not displayed on the monitor can be included in the third region set by user's manipulation, so that the region correction method is effective particularly when organs is complicated.

As described above, according to the region correction method of the present invention, the region in the correction range of the second region—which is a work region until acquisition of a three-dimensional region intended by the user—is limited within the range of the first region as a guide, so that manual correction is facilitated and the first region as a guide can ensure the objectivity of the region as the correction range. Since the first region and the second region are both displayed at the same time, the user easily estimates the correction result.

According to the region correction method of the invention, when acquiring the three-dimensional region intended by the user, to support the user for setting the third region by hand, a GUI is provided, so that region creation is made easier. Further, the third region is expanded in gradually, so that the correction part is also expanded in stages and the user can easily estimate the region to be corrected.

The invention is useful for the region correction method of correcting a region on volume data such as correcting the automatically extracted region of organs.

While there has been described in connection with the exemplary embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

What is claimed is:

1. A region correction method of correcting a three-dimensional region on volume data, said region correction method comprising:
(a) acquiring a first region as a guide and a second region as a work region;
(b) rendering the first region and the second region separately from each other;
(c) acquiring a third region specified by a user; and
(d) adding a region resulting from AND operation of the third region and the first region into the second region.

2. The region correction method as claimed in claim 1, wherein
in the step (c), a region set by user's manipulation is acquired as the third region.

3. The region correction method as claimed in claim 1, wherein
in the step (c), the third region is acquired by selecting from among a plurality of regions.

4. The region correction method as claimed in claim 1 further comprising:
(e) expanding the third region in stages.

5. The region correction method as claimed in claim 1, further comprising:
(f) changing the first region.

6. The region correction method as claimed in claim 1, further comprising:
(g) rendering only a region in the range included in a fourth region which is a part of the volume data.

7. The region correction method as claimed in claim 6, wherein
the third region includes a region not included in the fourth region.

8. A region correction method of correcting a three-dimensional region on volume data, said region correction method comprising:
(a) acquiring a first region as a guide and a second region as a work region;
(b) rendering the first region and the second region separately from each other;
(c) acquiring a third region specified by a user; and
(d) subtracting a region resulting from AND operation of the third region and the first region from the second region.

9. The region correction method as claimed in claim 8, wherein
in the step (c), a region set by user's manipulation is acquired as the third region.

10. The region correction method as claimed in claim 8, wherein
in the step (c), the third region is acquired by selecting from among a plurality of regions.

11. The region correction method as claimed in claim 8, further comprising:
(e) expanding the third region in stages.

12. The region correction method as claimed in claim 8, further comprising:
(f) changing the first region.

13. The region correction method as claimed in claim 8, further comprising:
(g) rendering only a region in the range included in a fourth region which is a part of the volume data.

14. The region correction method as claimed in claim 13, wherein
the third region includes a region not included in the fourth region.

15. An image-analysis apparatus having a region correction function to perform operations comprising:
(a) acquiring a first region as a guide and a second region as a work region;
(b) rendering the first region and the second region separately from each other;
(c) acquiring a third region specified by a user; and
(d) adding a region resulting from AND operation of the third region and the first region into the second region.

16. An image-analysis apparatus having a region correction function to perform operations comprising:
(a) acquiring a first region as a guide and a second region as a work region;
(b) rendering the first region and the second region separately from each other;
(c) acquiring a third region specified by a user; and
(d) subtracting a region resulting from AND operation of the third region and the first region from the second region.
